(19) United States
(12) Patent Application Publication
(10) Pub. No.: US 2018/0144260 A1
(43) Pub. Date: May 24, 2018

(54) HIGH-RISK ROAD LOCATION PREDICTION

(71) Applicant: International Business Machines Corporation, Armonk, NY (US)

(72) Inventor: Lucinio Santos-Gomez, Durham, NC (US)

(21) Appl. No.: 15/356,662

(22) Filed: Nov. 21, 2016

(51) Int. Cl. G06N 7/00; G01C 21/34

(52) U.S. Cl. CPC G06N 7/005; G01C 21/3453

(57) ABSTRACT

Embodiments of the invention provide a method, system and computer program product for high risk road location prediction. In an embodiment of the invention, a method for high risk road location prediction includes characterizing different portions of different roadways and computing a risk probability for each of the different portions based upon observed accident rates occurring at the different portions. The method additionally includes selecting a new portion of the different roadways for which a risk probability has not been computed, and characterizing the new portion. Finally, the method includes matching the new portion to one of the different portions based upon a common characterization and assigning a risk probability to the new portion based upon a computed risk probability for the one of the different portions matched to the new portion.

### BACKGROUND OF THE INVENTION

### Field of the Invention

The present invention relates to traffic monitoring data processing systems and methodologies and more particularly to predicting high-risk roadways in a data processing system.

### Description of the Related Art

Since the advent of the modern roadway, traffic prediction has been part and parcel of the every day life of the motorist. Originally confined to traffic reports on radio and telephonic traffic reporting, now advanced navigation standalone systems and simple online navigation services consider real-time traffic and roadway condition as part of the navigation suite of functionality. Generally, traffic and roadway conditions are received from over the air radio reports and also Internet sources, both government and non-government alike. As such, in response to an indication of traffic, a motorist end user of the navigation system may consider re-routing so as to avoid the roadway condition giving rise to traffic.

Navigation technologies also discover and reveal non-traffic conditions able to influence route decision making by individual motorists. Those non-traffic conditions include an indication of the presence of a freeway on a proposed route, the presence of a toll road on a proposed route and the requirement that a ferry transport the motorist in order to reach an intended destination. More recent proposed technologies also alert motorists to perceived dangerous roads on which motorists face a higher probability of suffering a motor vehicle accident or experiencing traffic due to a higher likelihood of a motor vehicle accident.

In this regard, studies have been conducted in which different locations of a roadway are associated with high long term crash rates so as to be labeled high risk locations. Indeed, in the past many have considered past accident data for different locations in order to provide for an accident forecast model. The accident forecast model then could be fed to a navigation system for presentation to a motorist so as to allow the motorist to consider re-routing to avoid high risk locations on a roadway.

### BRIEF SUMMARY OF THE INVENTION

Embodiments of the present invention address deficiencies of the art in respect to high risk location determination of a roadway and provide a novel and non-obvious method, system and computer program product for high risk road location prediction. In an embodiment of the invention, a method for high risk road location prediction includes characterizing different portions of different roadways and computing a risk probability for each of the different portions based upon observed accident rates occurring at the different portions. The method additionally includes selecting a new portion of the different roadways for which a risk probability has not been computed, and characterizing the new portion. Finally, the method includes matching the new portion to one of the different portions based upon a common characterization and assigning a risk probability to the new portion based upon a computed risk probability for the one of the different portions matched to the new portion.

In one aspect of the embodiment, each corresponding one of the different portions of the different roadways is characterized based upon an average speed of vehicles traversing the corresponding one of the different portions. In another aspect of the embodiment, each corresponding one of the different portions of the different roadways is characterized based upon an observed traffic density of each corresponding one of the different portions. In a further aspect of the embodiment, each corresponding one of the different portions of the different roadways is characterized based upon an observed average vehicle distance between vehicles traversing the corresponding one of the different portions. In a yet further aspect of the embodiment, each corresponding one of the different portions of the different roadways is characterized based upon observed weather for the corresponding one of the different portions. In even yet another aspect of the embodiment, each corresponding one of the different portions of the different roadways is characterized based upon a presence of construction work ongoing at the corresponding one of the different portions. Finally, in even yet another of the embodiment, each corresponding one of the different portions of the different roadways is characterized based upon road features of the corresponding one of the different portions.

In another embodiment of the invention, a data processing system is configured for high risk road location prediction. The system includes a host computing platform of one or more computers, each with memory and at least one processor. The system also includes a database of characterizations of different portions of different roadways that stores computed risk probabilities for each of the different portions based upon observed accident rates occurring at the different portions. Finally, the system includes a high risk road location prediction module executing in memory of the host computing platform. The module includes program code enabled upon execution in the memory of the host computing platform to select a new portion of the different roadways for which a risk probability has not been computed, and to characterize the new portion, to match the new portion to one of the different portions based upon a common characterization and to assign a risk probability to the new portion based upon a computed risk probability for the one of the different portions matched to the new portion.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for high risk road location prediction;

FIG. 2 is a schematic illustration of a data processing system configured for high risk road location prediction; and,

FIG. 3 is a flow chart illustrating a process for high risk road location prediction.

### DETAILED DESCRIPTION OF THE INVENTION

Embodiments of the invention provide for high risk road location prediction. In accordance with an embodiment of the invention, a frequency of motor vehicle accidents occurring on different portions of different roadways is determined and stored in a database, and different roadway characteristics of each of the portions also are identified and stored in the database. Thereafter, roadway characteristics of a new portion of the different roadways not included amongst the different portions of the different roadways are determined and compared to the stored characteristics of the different portions of the different roadways. One of the different portions of the different roadways with characteristics comparable to the characteristics of the new portion of the different roadways is identified and a risk corresponding to the frequency of motor vehicle accidents of the one of the different portions of the different roadways is assigned to the new portion of the different roadways. In this way, the risk of an accident on a new portion of the different roadways for which insufficient accident data is known can be assigned based upon the sufficient accident data of a comparable portion of the different roadways.

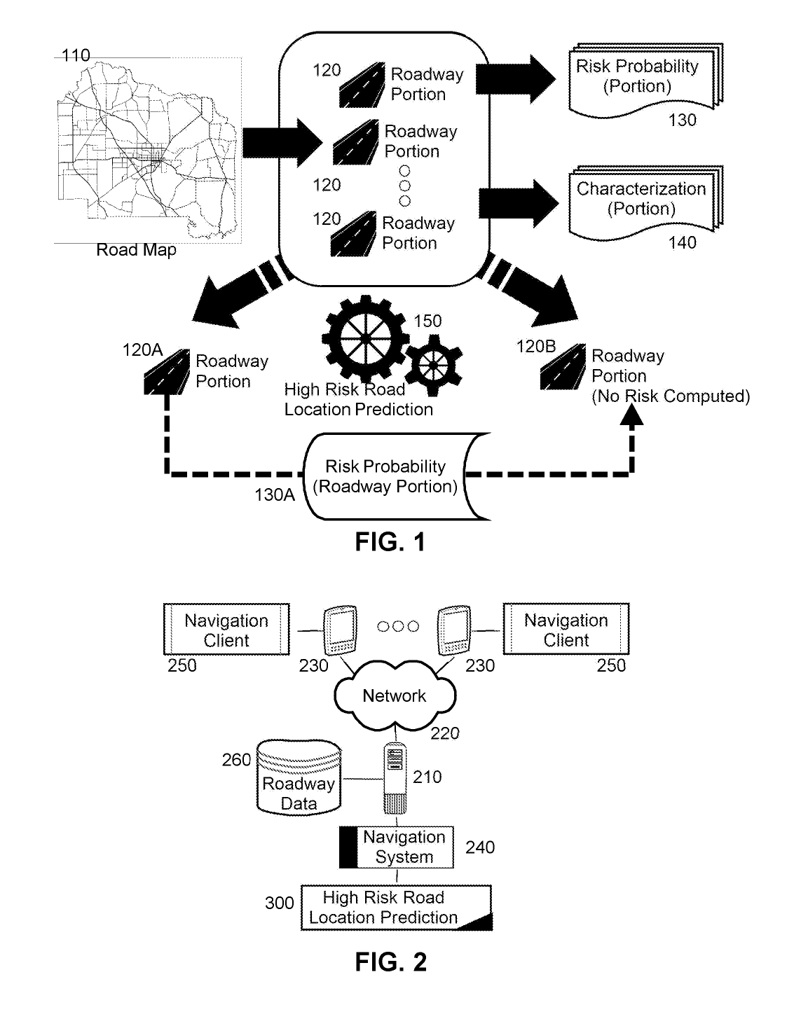

In further illustration, FIG. 1 pictorially shows a process for high risk road location prediction. As shown in FIG. 1, high risk road location prediction logic 150 processes different portions 120 of one or more roadways 110 by generating a characterization set 140 for each of the different portions 120. Each characterization set 140 includes different characterizations of a corresponding one of the different portions 120, such as an average speed of vehicles traversing the corresponding one of the different portions 120, an observed traffic density of a corresponding one of the different portions 120, an observed average vehicle distance between vehicles traversing the corresponding one of the different portions 120, observed weather for the corresponding one of the different portions 120, a presence of construction work ongoing at the corresponding one of the different portions 120, or road features of the corresponding one of the different portions 120, to name only a few examples.

As well, the high risk road location prediction logic 150 assigns a risk probability 130 to selected ones of the different portions 120. The risk probability indicates a probability that a motor vehicle accident might occur at a corresponding one of the different portions 120 based upon a past observed number of motor vehicle accidents as compared to others of the different portions 120 of the roadways 110. Notably, not all of the different portions 120 of the roadways 110 are assigned a risk probability 130 based upon the past observed number of motor vehicle accidents as compared to others of the different portions 120 of the roadways 110. Rather, the high risk road location prediction logic 150 assigns a risk probability 130 to an unassigned one 120B of the different portions 120 not yet assigned a risk probability 130 by comparing the unassigned one 120B of the different portions 120 to a comparably characterized one 120A of the different portions 120 and assigning the risk probability 130A of the comparably characterized one 120A of the different portions 120 to the unassigned one 120B of the different portions.

The process described in connection with FIG. 1 may be implemented in a data processing system. In yet further illustration, FIG. 2 schematically shows a data processing system configured for high risk road location prediction. The system includes a host computing platform 210 with one or more computers each with memory and at least one processor. The host computing platform 210 is communicatively coupled to different client computers 230 including personal computers, tablet computers and mobile devices. The system also includes a navigation system 240 supported by the host computing platform 210 and providing navigation services based upon different roadway data in a data store 260 to different end users in different navigation client applications 250 executing in respective ones of the client computers 230.

A high risk road location prediction module 300 is coupled to the navigation system and includes program code that when executed in the memory of the host computing platform 210, is enabled to provide for one portion of a roadway, a predicted risk probability based upon a computed risk probability for a different, but similarly characterized portion of a roadway. More particularly, when executing in the memory of the host computing platform 210, the program code is enabled to apply a geo-fence to a portion of a road network of one or more roadways within a given geographical area, and then to capture a characterization for the portion within the geo-fence. The characterization may refer to road types, signaled conditions, observed traffic or environmental conditions such as the observed, time temperature and weather conditions within a threshold distance of a reported traffic accident.

For instance, a road type characterization may include a type of road, be it a two or four lane road, expressway, freeway, access road, frontage road city street and the like. The road type characterization may also include a shoulder width, the presence, position, and length of road barriers, the presence of a right exit merge lane or left exit merge lane or an entrance ramp within a given distance. The road type characterization may further include the distance between intersections, the presence of road work, and the presence of road degradation within a given distance including potholes and uneven asphalt.

With respect to signaled road conditions, the characterization may include visibility or an icing likelihood, a signaled speed limit, the presence of an intersection within a given distance, the presence of a turning lane within a given distance, the presence of right-in or right-out three-way road intersection, the presence of an overpass within a given distance, the presence of a railroad crossing within a given distance, a road surface marking grade or the presence of a curve and the angle of road curving and distance from the location of a prior reported traffic accident.

Finally, with respect to traffic conditions, the characterization may include an average traffic speed within a geo-fence portion of a roadway, or an average traffic speed within a threshold distance from a reported traffic accident. As well, the characterization may include traffic density within a geo-fenced portion of a roadway or within threshold distance from a recorded traffic accident. As well, the characterization may include an average vehicle distance observed among vehicles in traffic within a threshold distance of a recorded accident.

In any event, the program code is yet further enabled to match the captured characterization to previously extracted characterizations for other portions of the road way and to predict whether or not the geo-fenced portion is of high risk for an accident based upon a risk factor already associated with the other portions of the road way with which the geo-fenced portion matches. In this regard, the program code may extract for different portions of a roadway at which a traffic accident has occurred, different patterns of a combination of different characterizations of the different portions of the roadway so as to correlate the combination of different characterizations with an unusual number of recorded traffic accidents. The extraction and pattern determination can occur continuously as new accident and characterization data is acquired. Then, for a newly selected portion of a roadway, the program code characterizes the selected portion and matches the selected portion to a different portion of the same or a different roadway sharing the most common of characterizations in order to assign to the selection portion the risk of a traffic accident observed at the matched portion.

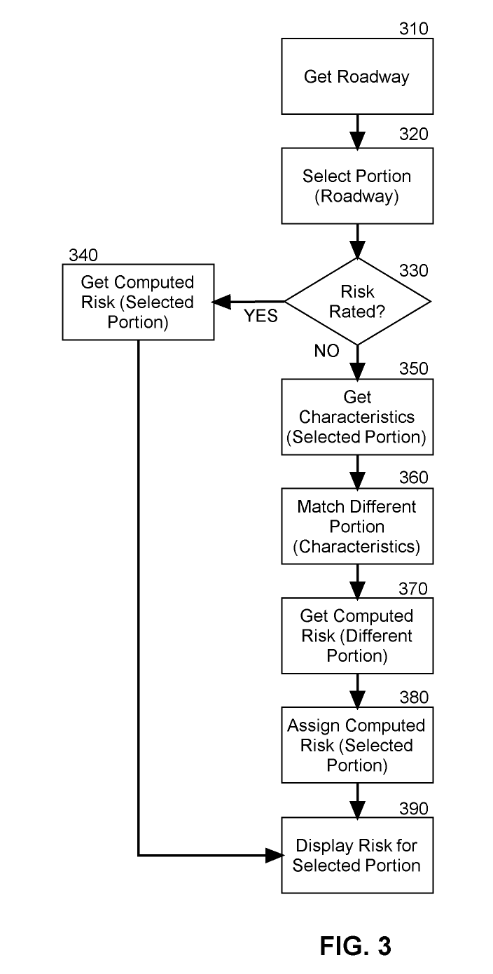

In even yet further illustration of the operation of the high risk road location prediction module 300, FIG. 3 is a flow chart illustrating a process for high risk road location prediction. Beginning in block 310, the high risk road location prediction module 300 selects a roadway from a database or roadways and in block 320, a portion of the roadway is further selected, for instance by applying a geo-fence to a segment of a map of roadways. In decision block 330, the high risk road location prediction module 300 determines if the selected portion of the roadway has already been assigned a risk of a traffic accident occurring. If so, in block 340 the high risk road location prediction module 300 retrieves into memory the previously assigned risk. Otherwise, the process continues through block 350.

In block 350, the high risk road location prediction module 300 acquires one or more characteristics of the selected portion of the roadway and in block 360, the high risk road location prediction module 300 matches the acquired characteristics to characteristics of other portions of the same or a different roadway. Then, in block 370 the high risk road location prediction module 300 obtains a risk assigned to the one of the other portions of the same or different roadway that is mostly similarly characterized as the selected portion. Finally, in block 380 the high risk road location prediction module 300 assigns to the selected portion, the risk assigned to the one of the other portions mostly similarly characterized as the selected portion, and in block 390, the high risk road location prediction module 300 displays the risk for the selected portion.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for high risk road location prediction, the method comprising:
characterizing different portions of different roadways;
computing a risk probability for each of the different portions based upon observed accident rates occurring at the different portions;
selecting a new portion of the different roadways for which a risk probability has not been computed, and characterizing the new portion;
matching the new portion to one of the different portions based upon a common characterization; and,
assigning a risk probability to the new portion based upon a computed risk probability for the one of the different portions matched to the new portion.

2. The method of claim 1, wherein each corresponding one of the different portions of the different roadways is characterized based upon an average speed of vehicles traversing the corresponding one of the different portions.

3. The method of claim 1, wherein each corresponding one of the different portions of the different roadways is characterized based upon an observed traffic density of each corresponding one of the different portions.

4. The method of claim 1, wherein each corresponding one of the different portions of the different roadways is characterized based upon an observed average vehicle distance between vehicles traversing the corresponding one of the different portions.

5. The method of claim 1, wherein each corresponding one of the different portions of the different roadways is characterized based upon observed weather for the corresponding one of the different portions.

6. The method of claim 1, wherein each corresponding one of the different portions of the different roadways is characterized based upon a presence of construction work ongoing at the corresponding one of the different portions.

7. The method of claim 1, wherein each corresponding one of the different portions of the different roadways is characterized based upon road features of the corresponding one of the different portions.

8. A data processing system configured for high risk road location prediction, the system comprising:
a host computing platform of one or more computers, each with memory and at least one processor;
a database of characterizations of different portions of different roadways, the database also storing computed risk probabilities for each of the different portions based upon observed accident rates occurring at the different portions; and,
a high risk road location prediction module executing in memory of the host computing platform, the module comprising program code enabled upon execution in the memory of the host computing platform to select a new portion of the different roadways for which a risk probability has not been computed, and to characterize the new portion, to match the new portion to one of the different portions based upon a common characterization and to assign a risk probability to the new portion based upon a computed risk probability for the one of the different portions matched to the new portion.

9. The system of claim 8, wherein each corresponding one of the different portions of the different roadways is characterized based upon an average speed of vehicles traversing the corresponding one of the different portions.

10. The system of claim 8, wherein each corresponding one of the different portions of the different roadways is characterized based upon an observed traffic density of each corresponding one of the different portions.

11. The system of claim 8, wherein each corresponding one of the different portions of the different roadways is characterized based upon observed weather for the corresponding one of the different portions.

12. The system of claim 8, wherein each corresponding one of the different portions of the different roadways is characterized based upon a presence of construction work ongoing at the corresponding one of the different portions.

13. The system of claim 8, wherein each corresponding one of the different portions of the different roadways is characterized based upon road features of the corresponding one of the different portions.

14. A computer program product for high risk road location prediction, the computer program product comprising a computer readable storage medium having program instructions embodied therewith, the program instructions executable by a device to cause the device to perform a method comprising:
characterizing different portions of different roadways;
computing a risk probability for each of the different portions based upon observed accident rates occurring at the different portions;
selecting a new portion of the different roadways for which a risk probability has not been computed, and characterizing the new portion;
matching the new portion to one of the different portions based upon a common characterization; and,
assigning a risk probability to the new portion based upon a computed risk probability for the one of the different portions matched to the new portion.

15. The computer program product of claim 14, wherein each corresponding one of the different portions of the different roadways is characterized based upon an average speed of vehicles traversing the corresponding one of the different portions.

16. The computer program product of claim 14, wherein each corresponding one of the different portions of the different roadways is characterized based upon an observed traffic density of each corresponding one of the different portions.

17. The computer program product of claim 14, wherein each corresponding one of the different portions of the different roadways is characterized based upon an observed average vehicle distance between vehicles traversing the corresponding one of the different portions.

18. The computer program product of claim 14, wherein each corresponding one of the different portions of the different roadways is characterized based upon observed weather for the corresponding one of the different portions.

19. The computer program product of claim 14, wherein each corresponding one of the different portions of the different roadways is characterized based upon a presence of construction work ongoing at the corresponding one of the different portions.

20. The computer program product of claim 14, wherein each corresponding one of the different portions of the different roadways is characterized based upon road features of the corresponding one of the different portions.
